(19) United States
(12) Patent Application Publication
(10) Pub. No.: US 2013/0092263 A1
(43) Pub. Date: Apr. 18, 2013

(54) Fluid Filter With Polymeric Membrane And Metal Supports

(71) Applicants: Entegris, Inc., Chaska, MN (US); Advanced Technology Materials Incorporated, Danbury, CT (US)

(72) Inventors: Anthony DiPrizio, Brookline, NH (US); Paul Matthews, Hudson, NH (US); Jose I. Arno, Brookfield, CT (US)

(73) Assignees: Advanced Technology Materials Incorporated, Danbury, CT (US); Entegris, Inc., Chaska, MN (US)

(21) Appl. No.: 13/707,109

(22) Filed: Dec. 6, 2012

Related U.S. Application Data
(62) Division of application No. 12/448,745, filed on Aug. 8, 2009.
(60) Provisional application No. 60/901,876, filed on Feb. 16, 2007.

(51) Int. Cl. F16L 55/24

(52) U.S. Cl. CPC F16L 55/24
USPC 137/544

(57) ABSTRACT

The present invention provides a fluid filter utilizing a polymeric membrane supports by metallic screens contained in a housing. The supports have apertures through which fluid can pass. The metallic supports are created such that they have at least one surface substantially free from burrs, so as not to damage the membrane. This smooth surface is in communication with the polymeric membrane. One or more indexing protrusions can be added along the circumference to restrict the relative movement between the supports, and to align the apertures of the two supports.

This application is a divisional of U.S. patent application Ser. No. 12/448,745 filed Aug. 8, 2009, which is a 371 of PCT/US2008/001541 filed Feb. 6, 2008, which claims priority of U.S. Provisional Patent Application Ser. No. 60/901,876, filed Feb. 16, 2007, the disclosures of which are incorporated herein by reference.

### BACKGROUND OF THE INVENTION

The difficulties with prior art filters include limited filter area, too much support material which is flow-restrictive as well as the nature of the materials used in such filter assembles. Such prior art filters are typically cylindrical perfluoroalkoxy (PFA) cores around which polymeric membrane is bonded. Such configurations lead to a capillary effect whereby multiple fluid paths leading to a single core and this configuration require support structures that constrict flow.

The present invention is a fluid filter, which can be used within a container, such as a gas bottle, to filter the fluid within before releasing it. The present invention solves the problems of the prior art by using a novel combination of housing, metallic support structure and polymeric membrane to allow for higher volumetric flow. This results in a filter assembly with a smaller footprint, thereby providing the gas bottle with more capacity.

The particular features of the present invention include a flat membrane sheet sandwiched between two metal lattice supports or screens having apertures of specific dimensions. It is atypical to support a flat membrane with stainless steel screen as such materials would typically cut the membrane. As such, the supports of the present invention must be flat and include surfaces free of burrs.

Currently available materials such as wire meshes are inadequate. Porous polytetrafluoroethylene (PRFE) supports are not desirable due to the cost and difficulty of sealing the PTFE supports with the membrane and housing.

It is a further advantage of the present invention that the metallic supports provide sealing surfaces that facilitate sealing the membrane to the housing. Preferably, such sealing is facilitated by o-rings, preferably polytetrafluoroethylene Teflon® o-rings.

In a preferred embodiment of the present invention, the metal used for such screens is stainless steel, and in particular 316L.

Aperture shape can be round, oval or can be a sided figure such as a hexagon, but in the preferred embodiment, it is round.

The present invention includes a fluid filter configured for use in a gas bottle. More specifically, the present invention is directed for use in a vacuum actuated gas bottle. It is a common problem in the gas bottle business to deliver gas that is substantially free of particulate contaminants that shed from the bottle and the matrix materials typically found in such gas bottles.

### BRIEF DESCRIPTION OF THE FIGURES

FIG. 1 provides a cross-section of a filter of the present invention.

FIG. 2 provides a partial cross-section of filter of the present invention contained in a gas bottle.

FIG. 3 provides a view of the filter housing of the present invention.

FIG. 4 provides a view of a retainer nut for the housing of the present invention.

FIG. 5 provides a top view of a membrane support of the present invention.

FIG. 6 provides a view of an assembled fluid filter of the present invention.

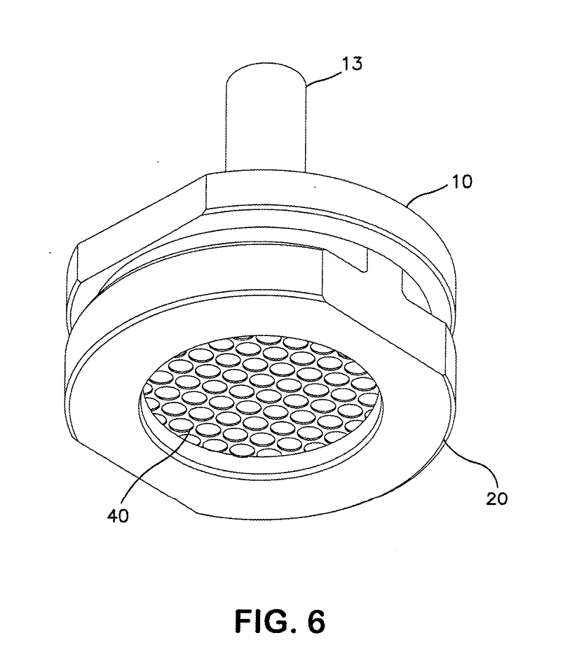

### DETAILED DESCRIPTION OF THE INVENTION

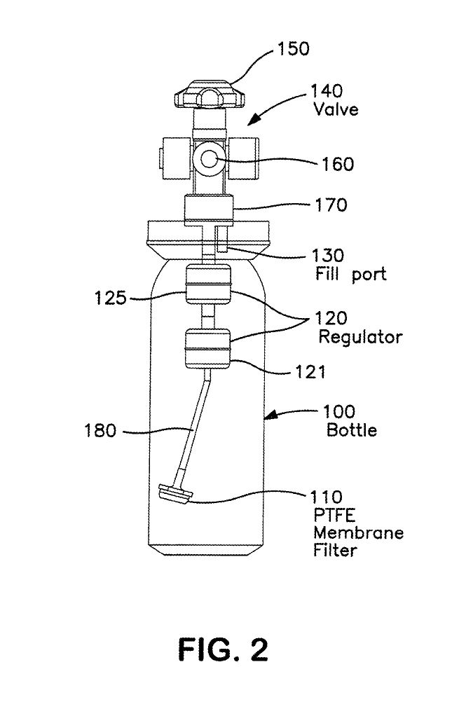

FIG. 2 illustrates a vacuum or pressure actuated gas bottle or cylinder 100, in which the present invention is preferably used. The gas bottle or cylinder 100, which is typical 12 inches long and has a diameter of about 4.25 inches, has a valve 140 connected to its sole opening 170. This connection must be airtight, and is preferably achieved via welding, but can also be achieved with mating threads and the appropriate metal gasket or o-ring. The valve 140 controls the flow of fluid between the cylinder and the external environment. Knob 150, typically located on the top of valve 140 is typically rotated to allow the release of stored fluid, preferably gas, from within the cylinder 100. This rotation of knob 150 allows the stored fluid to pass through filter 110, conduit 180, the regulator 120 and to flow out though outlet 160. The gas cylinder 100 is also refilled with fluid, typically gas, via valve 140. Pressurized gas enters valve 140 via an outlet 160 and is transferred to the gas cylinder 100 via the fill port 130.

Within the gas cylinder 100 is a two stage regulator 120 which regulates the pressure of the exiting fluid. The first stage 121 accepts pressurized gas from within the cylinder and converts it to an intermediate pressure. The gas at this intermediate pressure then flows to the second stage of the regulator 125, which adjusts the intermediate pressure to the desired output pressure. This regulator configuration allows the output pressure of the exiting fluid to remain relatively constant as the fluid within the cylinder 100 is depleted. Alternatively, the gas cylinder may not be under pressure, but rather at atmospheric pressure, requiring an external vacuum to draw out fluid. While a two stage regulator is preferred, the present invention can also be utilized with a single stage regulator.

The stored, pressurized fluid enters the first stage 121 of the regulator 120 via the filter 110. Filter 110 is used to remove contaminants and other particulates from the fluid before passing it through conduit 180 to the first stage 121 of the regulator 120. The conduit can be any suitable material, but is preferably 316L.

In some applications, a PTFE membrane and stainless steel filter housing are necessary, as the application requires a non-contaminating flow path. However, for less demanding applications, those of ordinary skill in the art could substitute other membranes, including but not limited to PVDF, UHMWPE and PES. Similarly, other metals, such as stainless steel alloys, may be substituted for the metallic supports.

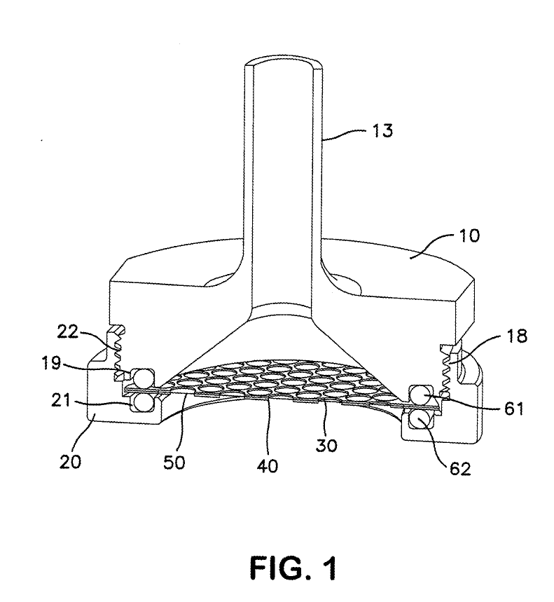

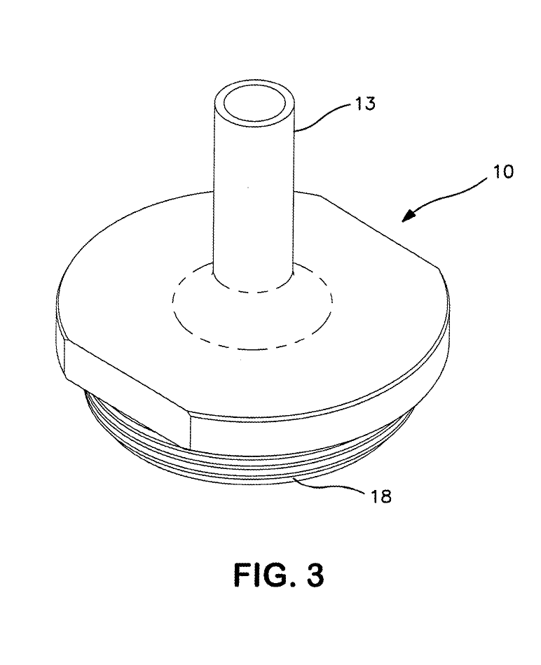

A perspective cross-sectional view of a suitable filter 110 is shown in FIG. 1. Filter housing 10 is preferably about 1.1 inches tall. It preferably includes an axially extending narrow neck portion 13 adapted to connect to conduit 180 (as seen in FIG. 2) to allow fluid communication between the filter 110 and the regulator 120. The neck preferably has a diameter of about 0.25 inches, and a length of about 0.75 inches. The neck preferably connects to the conduit by welding, but could also be connected using metal face seal or compression fittings. Beginning at the lower portion of the neck portion 13, the filter housing 10 tapers outwardly, preferably in the shape of a frustum, with the filter membrane 50 preferably positioned at the base of the frustum. In one embodiment, the base of the frustum has a diameter of about 0.77 inches, although other sizes are within the scope of the invention. In the preferred embodiment, the outer surface of the lower portion of the filter housing 10 contains spiraling screw threads 18. Retainer nut 20 preferably has corresponding spiraling screw threads 22 along its inner upper portion. These sets of screw threads allow the retainer nut 20 to be screwed onto the filter housing 10. While this configuration is preferably due to ease of assembly, repair and membrane replacement, other configurations are possible. For example, retainer nut 20 can be permanently affixed to filter housing such as by welding. A perspective view of the filter housing 10 with the spiraling screw threads is shown in FIG. 3. The retainer nut 20 and the filter housing 10 cooperate to retain the filter 50 (and the supports 30, 40) in position.

In one embodiment, one or more small dimples can be made between two adjacent threads, such as by using a sharp pointed instrument, preferably a center punch. Such dimples cause the adjacent screws to move slightly closer to one another, thereby creating the tighter fit. Preferably, dimples would be placed on opposite sides of the housing 10, most preferably 180° apart. In another embodiment, the filter housing and retainer nut are attached together (such as by screwing) and then welded or melted together to prevent inadvertent separation between the pieces.

Membrane 50 is positioned with the filter housing 10 and the retainer nut 20. In one embodiment, the diameter of the membrane is about 0.95 inches, although the invention is not so limited. The membrane functions to remove contaminants and other particulates from the outgoing fluid. In a preferred embodiment of the present invention, the membrane is a polytetrafluoroethylene (PTFE) membrane commercially available from W.L. Gore & Associates, Inc. of Elkton, Md., such as part number S30016. Other membranes deemed suitable by those skilled in the art are within the scope of the invention.

Upper support 30 and lower support 40 are positioned above and below filter membrane 50. In the preferred embodiment, the supports 30,40 each have the same diameter as the membrane. The supports give rigidity and stability to the porous membrane. The supports can be any suitable material, and are typically made from materials that are non-corrosive and chemically compatible with the stored fluid. In a preferred embodiment, the supports are metal, and in a particularly preferred embodiment, they are made from 316L stainless steel.

The membrane 50 is sealed in the filter housing 10 in order to prevent fluid from passing into the filter housing 10 without passing through the filter membrane 50. In the embodiment shown in FIG. 1, two o-rings 61 and 62 are used, with one positioned on the top of support 30, and the other positioned under support 40. The filter housing 10 and the retainer nut 20 both have an annular cavity 19 and 21, respectively, into which an o-ring is placed. The cavities are created such that their depth is slightly less than the uncompressed thickness of the respective o-ring. In one embodiment, these cavities are about 0.050 inches deep, while the o-ring has a thickness of about 0.070 inches. Thus, when the filter housing and retainer nut are attached, these o-rings are placed under compression, thereby providing a seal along the circumference of the membrane. While o-rings are shown in this embodiment, the invention is not so limited. Other mechanisms known to those skilled in the art may be used to create the required seal.

The membrane 50 is positioned between two metallic supports 30 and 40. Previously, metallic supports were unsuitable for such an application, due to their propensity to puncture or tear the delicate membrane. However, these problems have been overcome by the present invention. To achieve this result, the metallic supports must be substantially smooth and burr-free. This result can be achieved in a variety of ways.

In one embodiment, the metal support is stamped. The stamping process typically results in the metal piece having one surface that is smooth, while the opposite side contains burrs. In one instantiation, the metallic supports 30 and 40 are assembled such that the smooth sides face the membrane. In another instantiation, the burrs are polished off the opposite side before assembly.

In another embodiment, the metal supports are created via laser cutting. Again, this process typically creates a metal piece having one surface that is smooth, while the opposite side contains burrs. As above, in one instantiation, the metallic supports 30 and 40 are assembled such that the smooth sides face the membrane. In another instantiation, the burrs are polished off the other side before assembly. In another instantiation, chemical etching is used to remove the burrs prior to assembly.

In a third embodiment, the metallic supports are created via photochemical machining. The process of photochemical machining involves several distinct steps. First, a multiple-image phototool is produced on film. The metal sheet to be etched is then coated with photoresist. After the photographic image on the phototool has been transferred to the coated metal surface, the metal sheet is developed, removing the resist in areas that are to be etched. Then a controlled acid etch is sprayed onto the metal surface to selectively dissolve the metal away. Once the etching process is complete, the photoresist is stripped. Finally, finishing and forming operations can be performed. This process is well known to those of ordinary skill in the art. Various entities, such as Photofabrication Engineering, Inc. of Milford, Mass., can provide such services. This process yields an article with two smooth sides.

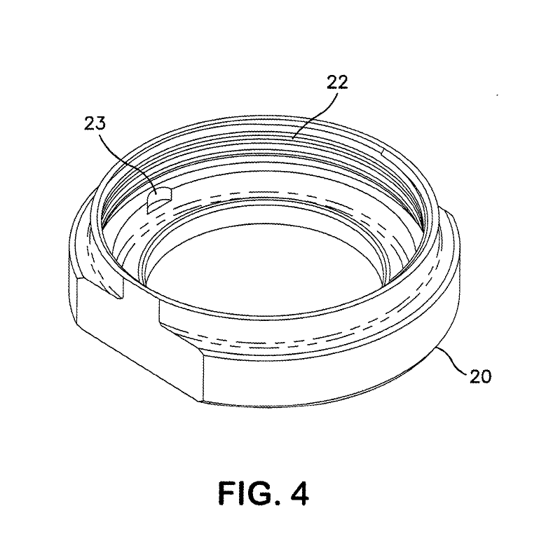

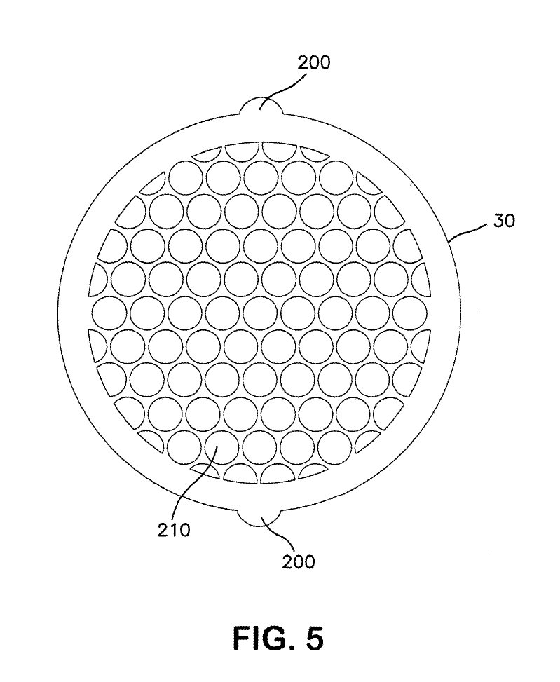

FIG. 4 provides an enlarged view of an embodiment of the retaining nut of the present invention. It provides a flight of screw threads 22 to receive the filter housing 10. It further provides an indexing notch 23, with a preferred embodiment having two such notches, preferably positioned 180 degree apart. The notch or notches 23 mate with the corresponding protrusion or protrusions that are provided on the outer circumference of the metallic supports 30 and 40. FIG. 5 shows an enlarged view of a metallic support, with the indexing protrusions 200. In an alternative embodiment, the filter housing may have the protrusion, while the metallic supports have the indexing notches.

In operation, the lower metallic support 40 is inserted into the retainer nut 20 such that it rests on the Teflon o-ring and its protrusion(s) align with the notch(es) on the retainer nut. Next, the membrane 50 is placed atop the lower metallic support. Finally, the upper metallic support 30 is placed on the membrane 50 with its protrusions aligned with the notches in the retainer nut 20. The retainer nut 20 is then attached to the filter housing 10, which already has another Teflon o-ring installed. Two important purposes are served by this indexing system. First, the two metallic supports have a fixed relationship to one another, thereby allowing their respective apertures to be aligned in a predetermined configuration. Secondly, the indexing forces the metallic supports to remain stationary, even while the retainer nut and the filter housing are being screwed together and the Teflon o-rings are being compressed. Without this indexing, the metallic supports may turn as the filter housing and retainer nut are twisted together, potentially twisting or tearing the membrane. In this way, the membrane remains stationary and thus remains integral.

FIG. 5 shows an enlarged view of the metallic support. As described above, it comprises one, preferably two, indexing protrusions 200, the functions of which have been described previously. The metallic support 30 also has a plurality of apertures 210, through which the fluid may pass. These apertures can be a variety of shapes, including but not limited to circular, oval, polygonal, or other shapes. The polygon may be square, pentagon, hexagon, octagon, or any other shape. In the preferred embodiment, the ratio of the amount of open area to the total area of the metallic support should be as great as possible, to minimize pressure drop and still provide adequate membrane support. In the preferred embodiment, the protrusions are circular, with a diameter of about 0.080 inches. The metallic support 30 has a thickness of about 0.010 inches. The metallic support 40 is similarly configured, such that when in the assembled condition, the apertures 210 of the support 40 align with the apertures 210 of the support 30.

The above configuration has additional advantages. For example, the membrane can be easily replaced. By simply unscrewing the retainer nut 20 from the filter housing 10, the metallic supports and membrane are exposed. These components can be easily removed from the retainer nut and replaced as part of ordinary maintenance or in the event of damage.

What is claimed is:

1. A pressurized gas cylinder, comprising:
a valve;
a regulator; and
a fluid filter, comprising:
a polymeric filter membrane;
first and second metallic filter supports, each of said supports having a protrusion along its respective outer edge to be used for alignment, said filter supports adapted to sandwich and be in physical contact with said filter membrane;
first and second sealing elements adapted to press against said first and second filter supports, respectively;
a first portion of a filter housing comprising:
spiraling screw threads; and
a cavity into which said first sealing element is placed;
a second portion of said filter housing comprising:
spiraling screw threads, wherein said first and second portions are adapted to be screwed together via said spiraling screw threads located on both of said portions;
a cavity into which said second sealing element is placed; and
a notch into which said protrusions on both of said metallic filter supports fit, allowing apertures of two metallic supports to be aligned in a predetermined configuration, and eliminating the rotational movement of said metallic filter supports, such that the supports remain stationary with respect to each other as said first and second portions of the filter housing are screwed together;
wherein gas in said cylinder passes through said fluid filter and said regulator and exits through said valve.

2. The pressurized gas cylinder of claim 1, wherein said metallic supports are formed by stamping.

3. The pressurized gas cylinder of claim 2, wherein said stamped metallic filter supports comprises one substantially smooth surface and one which has burrs, and wherein said smooth surfaces face said membrane.

4. The pressurized gas cylinder of claim 3, wherein said surfaces which have burrs are polished prior to assembly in said filter housing.

5. The pressurized gas cylinder of claim 1, wherein said metallic filter supports are formed by laser cutting.

6. The pressurized gas cylinder of claim 5, wherein said laser cut metallic filter supports comprise one substantially smooth surface and one which has burrs, and wherein said smooth surfaces face said membrane.

7. The pressurized gas cylinder of claim 6, wherein said surfaces which have burrs are polished prior to assembly in said filter housing.

8. The pressurized gas cylinder of claim 1, wherein said metallic filter supports are formed by photochemical machining.

9. The pressurized gas cylinder of claim 1, wherein said metallic filter supports comprise a plurality of apertures.

10. The pressurized gas cylinder of claim 9, wherein said apertures are circular.

11. The pressurized gas cylinder of claim 1, wherein each of said metallic filter supports comprises a plurality of apertures, and said protrusions are positioned so as to align said apertures of said first and second metallic filter supports.

12. The pressurized gas cylinder of claim 1, wherein said metallic filter supports are stainless steel.

13. A pressurized gas cylinder, comprising:
a valve;
a regulator; and
a fluid filter, comprising a polymeric membrane positioned between, and in constant physical contact with, a first metallic support and a second metallic support, and a filter housing, wherein the surfaces of said metallic supports in physical contact with said membrane are substantially smooth so as not to damage said membrane.

14. The pressurized gas cylinder of claim 13, wherein said metallic supports are formed by stamping.

15. The pressurized gas cylinder of claim 14, wherein said stamped metallic supports each comprise one substantially smooth surface and one which has burrs, and wherein said smooth surfaces face said membrane.

16. The pressurized gas cylinder of claim 15, wherein said surfaces which have burrs are polished prior to assembly in said filter housing.

17. The pressurized gas cylinder of claim 13, wherein said metallic supports are formed by laser cutting.

18. The pressurized gas cylinder of claim 17, wherein said laser cut metallic supports each comprise one substantially smooth surface and one which has burrs, and wherein said smooth surfaces face said membrane.

19. The pressurized gas cylinder of claim 18, wherein said surfaces which have burrs are polished prior to assembly in said filter housing.

20. The pressurized gas cylinder of claim 13, wherein said metallic supports are formed by photochemical machining.
